(19) United States
(12) Patent Application Publication
(10) Pub. No.: US 2026/0167421 A1
(43) Pub. Date: Jun. 18, 2026

(54) METHOD FOR THE STOCKING OF GOODS IN AN AUTOMATED STORAGE AND RETRIEVAL SYSTEM

(71) Applicant: Autostore Technology AS, Nedre Vats (NO)

(72) Inventors: Kenneth Müller, Vormedal (NO); Geir Vikingstad, Haugesund (NO); Jørgen Djuve Heggebø, Langhus (NO); Audun Sagen, Oslo (NO); Øystein Gjerdevik, Skjold (NO); Amund Skålerud, Etne (NO); Joakim Aleksander Myrbakken, Skudeneshavn (NO)

(73) Assignee: Autostore Technology AS, Nedre Vats (NO)

(21) Appl. No.: 19/124,417

(22) PCT Filed: Oct. 26, 2023
(86) PCT No.: PCT/EP2023/079881

§ 371 Date: Apr. 25, 2025

(30) Foreign Application Priority Data
Oct. 28, 2022 (NO) 20221156
Dec. 2, 2022 (NO) 20221296

(51) Int. Cl. B65G 1/04; B65G 1/137

(52) U.S. Cl. CPC B65G 1/0464; B65G 1/0485; B65G 1/0492; B65G 1/1373

(57) ABSTRACT

A method for stocking goods into an automated storage and retrieval system, where goods are packed into one or more storage containers (106). The stocked containers (106) are thereafter transported to the storage system (104). The goods are stocked by “inserting” the container (106) into the system (104), using preferably a container insertion device (614), the insertion operation including: —affixing an identification label to the container (106), the identification label comprising identifying information about the container (106), —confirming that the physical dimensions of the container (106) are within predefined tolerances, —affixing a goods label to the container (106), the goods label containing information about the goods within the container, —scanning the labels or otherwise entering the identifying information into a control system and warehouse management system of the automated storage and retrieval system, —retrieving the containers (106) by a container handling vehicle and transporting the container to a storage column.

### FIELD OF THE INVENTION

The present invention relates to an automated storage and retrieval system for storage and retrieval of containers, in particular to a method for the improved transportation and stocking of goods in an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing.

These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. In addition to storage columns 105, there are special-purpose columns within the framework structure. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

### Transportation and Stocking of Goods

As described above, the storage containers in an automated storage and retrieval system 1 are filled with goods. For example, the goods may be consumer products intended to be delivered to a customer. Alternatively, the goods may be parts or components needed by the owner of the facility for its own purposes. In any event, in most cases the goods are delivered from a point of origin, such as a manufacturer or a distributor, to the automated storage and retrieval system where the goods are placed in storage containers that are presently operating within the system.

Typically, goods are packed at for example a manufacture in cardboard shipping containers. The goods are then transported to the automated storage and retrieval facility directly, or often transported first to a distribution center. At a distribution center the goods are often removed from their original cardboard shipping container and placed in different sized cardboard shipping containers for shipping to various locations, including the automated storage and retrieval system. Once at the automated storage and retrieval system, the goods are removed from the cardboard shipping container and stocked into the system.

Such stocking is typically performed at an access station by personnel placing the goods into empty storage containers or replenishing partially filled storage containers that are currently in operation within the system. The goods are often registered into a warehouse control system which tracks the location and quantity of goods stored in the facility.

As can be appreciated, the current method of stocking goods results in large amounts of cardboard waste. In addition, the personnel at the access station are often diverted from the task of filling customer orders while performing the stocking operation, which negatively impacts the throughput of the system.

### Inserting Storage Container into an Automated Storage and Retrieval System

When new containers are introduced into an automated storage and retrieval system, the containers must first be prepared for introduction in the system. This operation is known as a “bin insert” or “storage container insert” operation. The insert operation comprises affixing an identification label comprising a machine-readable identification code to a new, empty container and registering the container into the control system for the facility. The physical dimensions of the container are scanned or otherwise measured to ensure that the size of the container is within predefined tolerances. The newly registered and measured container is then introduced into the system by personnel working at an access station. As in the case of restocking at an access station, the bin insert operation also diverts the access station personnel from fulfilling customer orders, again negatively impacting system throughput.

### SUMMARY OF THE INVENTION

The present invention is set forth and characterized in the independent claims, while the dependent claims describe other characteristics of the invention.

In one aspect, the invention is related to a method for improved logistics for stocking and restocking goods in an automated storage and retrieval system. According to this aspect, goods to be stocked or restocked are packaged at a point of origin into storage containers of the type actually utilized in the storage and retrieval system, i.e. storage containers of identical type to the containers that are stacked in storage columns and retrieved/transported by the container handling vehicles of the system. The storage containers filled with goods are transported to the automated storage and retrieval facility, either directly or via a distribution center. Because the goods are already placed in storage containers of the type utilized by the system, it may be possible in many instances to hop over the distribution center step of the transportation logistics where such step would have otherwise been advantageous. A further advantage is that since such storage containers are specifically designed to be stored in stacks, the containers are easily stacked in a delivery vehicle. At the storage system facility, the goods are restocked by “inserting” the filled containers into the system. As used herein, the term “inserting” a storage container or “bin” into an automated storage and retrieval system is meant as a term of art, comprising the steps of affixing an identification label comprising a machine-readable identification code to a new container and registering the container into the control system for the facility. The physical dimensions of the container are scanned or otherwise measured to ensure that the size of the container is within predefined tolerances. The goods may further be registered into a warehouse management system that tracks the inventory of goods within the automated storage and retrieval system. As can be appreciated, the above described method avoids the use of cardboard shipping containers, thus avoiding cardboard waste.

According to another aspect of the invention, the goods are stocked/restocked into the storage and retrieval system by the containers containing the goods being “inserted” into the storage and retrieval system by a dedicated, automated container insertion device. The device is arranged to directly insert storage containers into an empty storage column of the storage system, thus avoiding the use of an access station to insert the container. Thereby, the personnel of the access station are not diverted from the task of filling customer orders, and the stocking/restocking may be performed automatically. According to this aspect, the storage containers filled with goods may have affixed thereto a machine-readable label identifying the goods within the container. The label could be in the form of a barcode, rfid or similar embodiments. This label may be read by the scanning device of the automated container insertion device and registered into the warehouse management system automatically. The container insertion device employed in this aspect of the invention may be an automated device as described in priority application NO20221156, filed 28 Oct. 2022. A copy of the specification in NO20221156 is attached hereto as appendix A, and forms a part of the present disclosure. The description in Appendix A also refers to FIGS. 1-12 herein.

According to one aspect, the invention provides a method for stocking and/or restocking goods into an automated storage and retrieval system, the automated storage and retrieval system comprising a framework structure comprising a plurality of upright members defining a plurality of storage columns, said storage columns adapted to store stacks of storage containers, said storage containers comprising means to interface with a gripping device of an automated container handling vehicle operating on a rail system of the framework structure and thereby to be gripped by and lowered into or raised out of the storage columns by the vehicle, the method comprising the steps of:
a. packing the goods into one or more of said storage containers at a point of origin in order to form one or more stocked containers,
b. transporting the stocked container or containers from the point of origin to the automated storage and retrieval system location,
c. inserting the stocked container or containers into the automated storage and retrieval system, the step of inserting comprising;
   i. affixing an identification label to a stocked container, the identification label comprising identifying information about the container,
   ii. confirming that the physical dimensions of the container are within predefined tolerances,
   iii. scanning the label or otherwise entering the identifying information into a control system of the automated storage and retrieval system,
   iv. entering information about the goods within the stocked container into a warehouse management system,
   v. retrieving the stocked containers by a container handling vehicle and transporting the stocked container to a storage column.

In one aspect, the insertion operation is performed by an automated container insertion device.

According to another aspect, the present invention provides an automated storage and retrieval system as described in the background section, and comprising a logistics routine for the stocking or restocking of goods, the logistics routine comprising the method described above.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a storage column, showing upright members with guide profiles.

FIG. 6 is a perspective view of an automated storage and retrieval system with an opening in a lower part of a wall enclosing the framework structure, exposing a storage column.

FIG. 7 depicts an embodiment of a container insertion device rolled adjacent the opening in wall enclosing the framework structure from FIG. 6.

FIG. 8 is a perspective cut-away view of an embodiment of a container insertion device.

FIG. 9 illustrates a storage container being checked for dimensions and scanned by a scanner before insertion into the storage column of the automated storage and retrieval system.

FIG. 10 depicts a storage container resting on an exit platform of the device and positioned in a storage column.

FIG. 11 illustrates the storage container resting on the exit platform of the container insertion device within the storage column, awaiting to be picked up by a container handling vehicle of the storage system.

FIGS. 12A and 12 B-illustrate an empty storage column adjacent the opening in the wall from FIG. 6, showing different embodiments of an opening in the guide profiles permitting lateral insertion of a container into the storage column. FIG. 12A shows segments of faces of the guide profiles removed, while FIG. 12B show hinged segments of faces of the guide profiles.

FIG. 13 is a flow chart illustrating the steps of the method for stocking goods according to the present invention

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

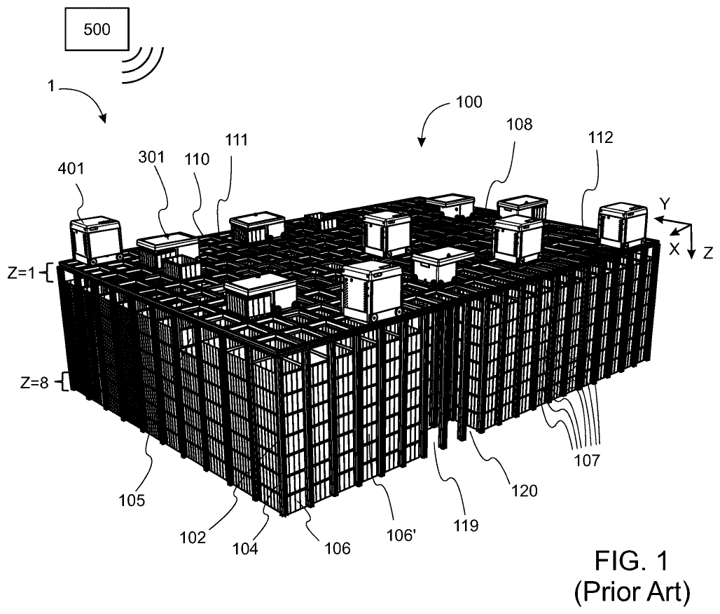

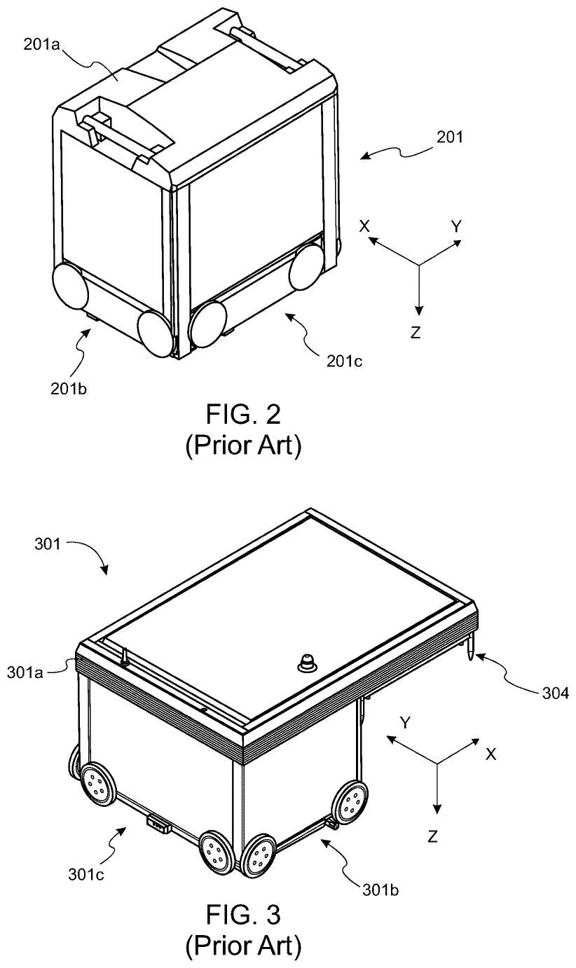

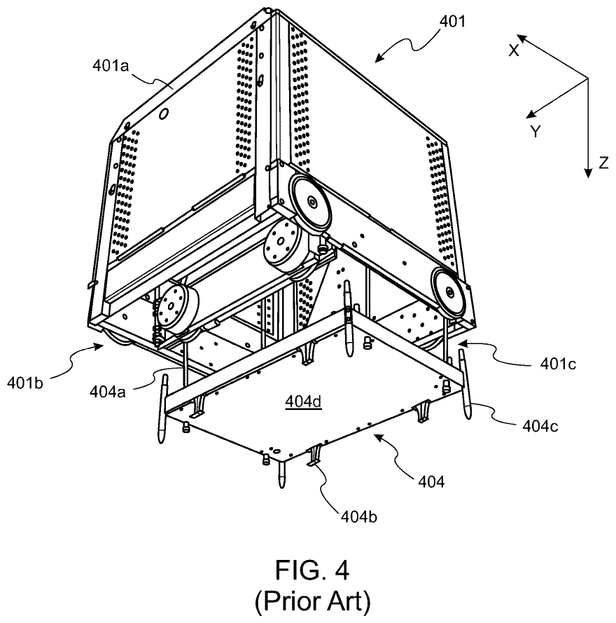

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

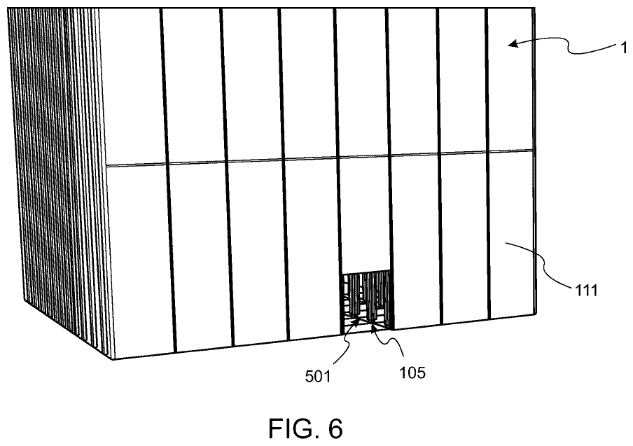

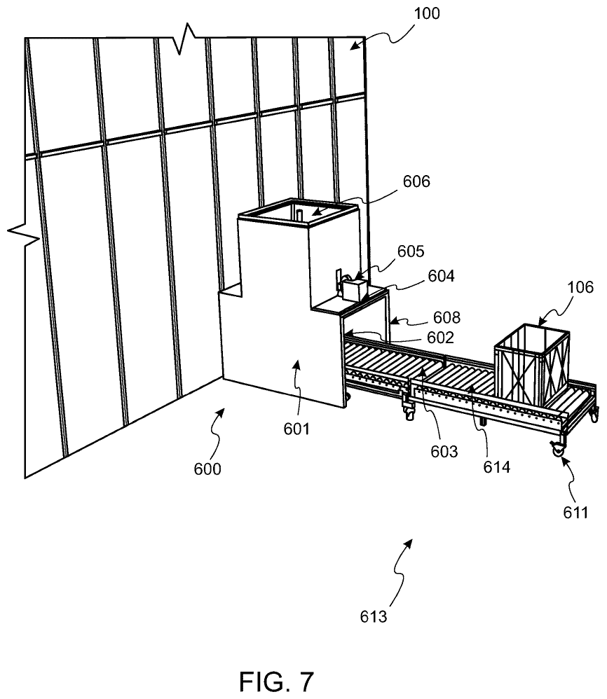

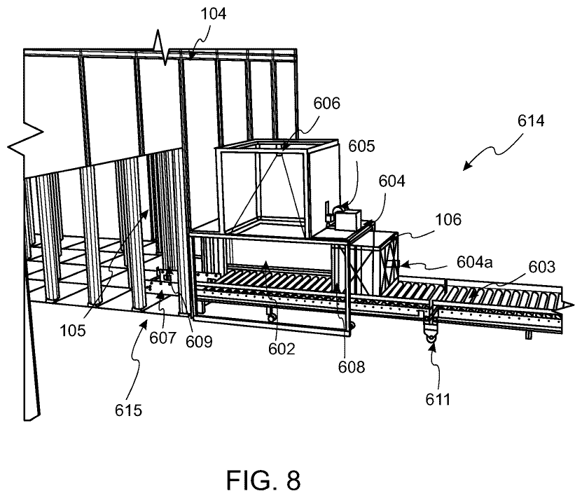

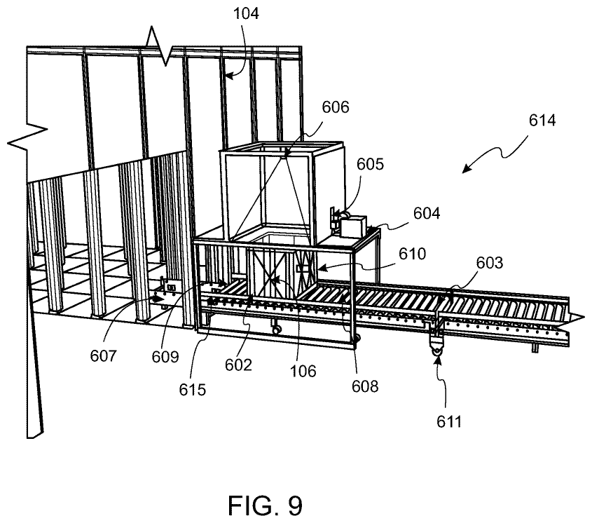

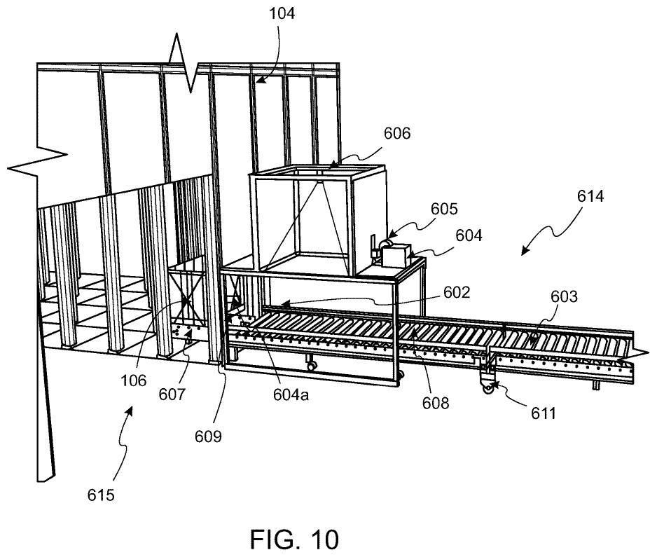

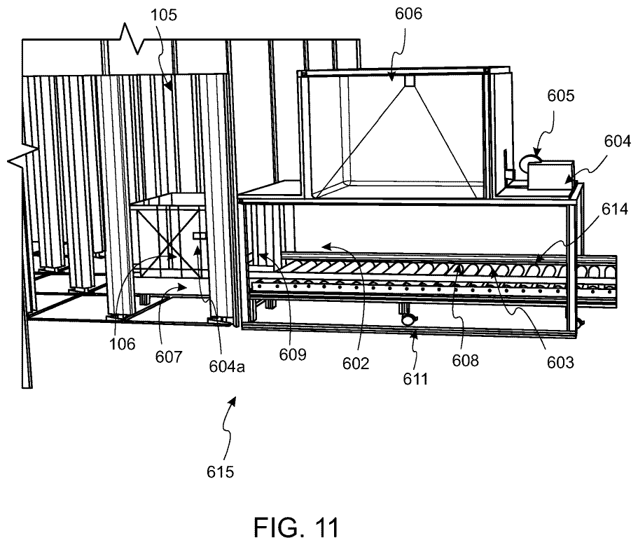

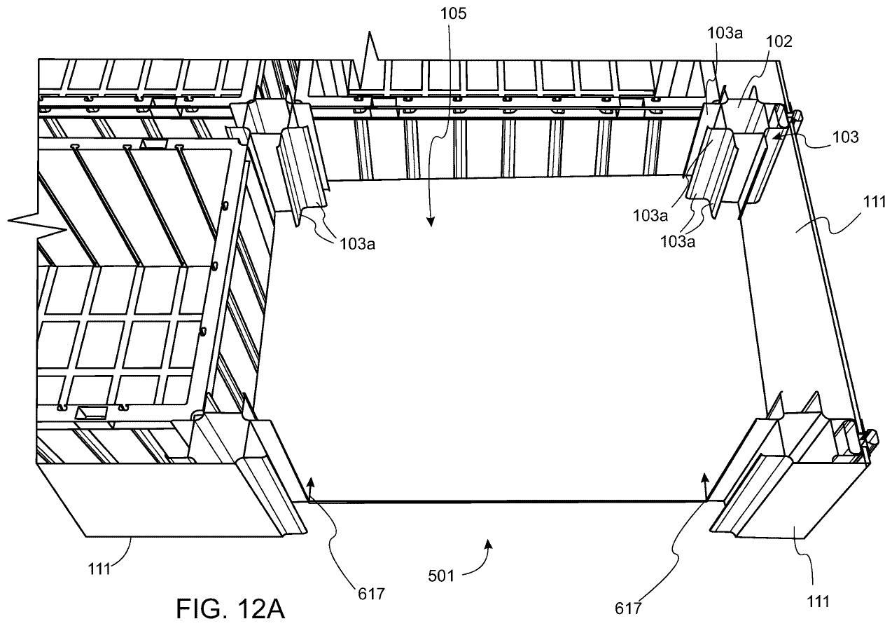

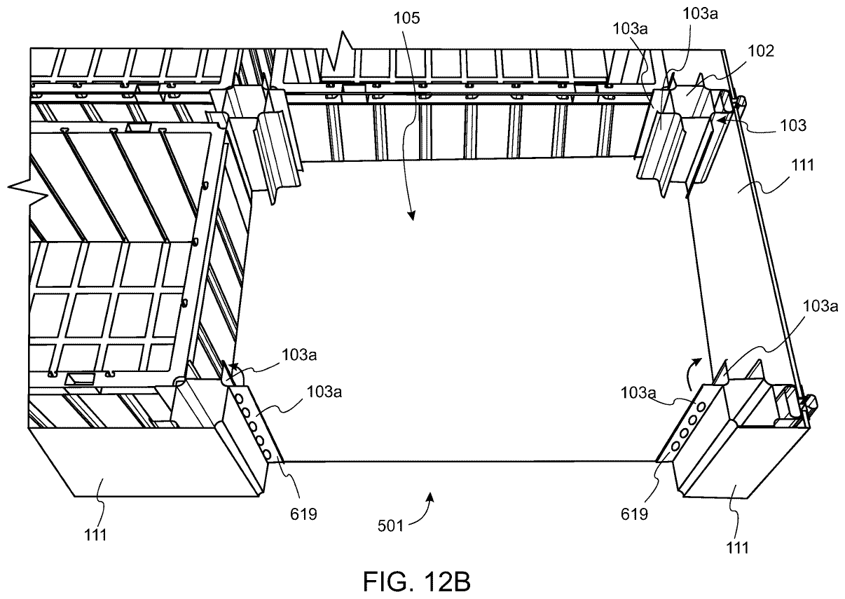

One embodiment of the automated storage and retrieval system according to the invention will now be discussed in more detail with reference to FIGS. 5-13.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

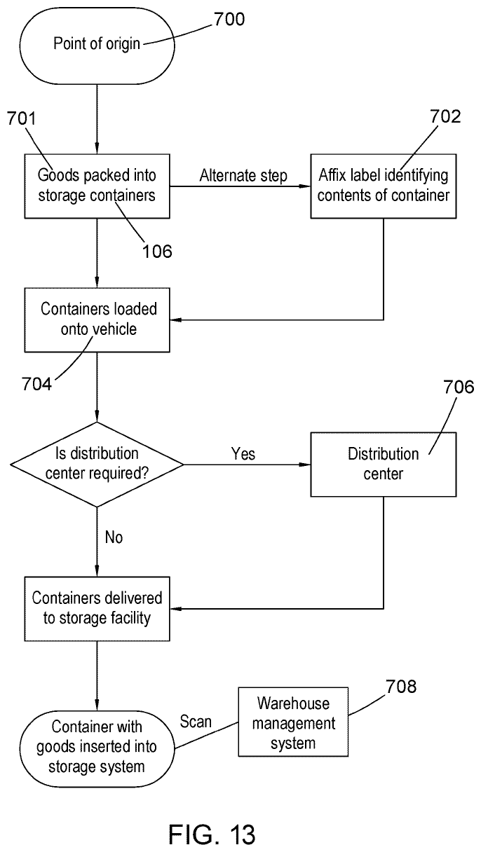

According to one aspect, the invention is related to a method for improved logistics for stocking and restocking goods in an automated storage and retrieval system, as illustrated in FIG. 13. As shown, goods 701 originating from a point of origin 700, for example a manufacturer of goods, are packaged into storage containers 106. Containers 106 containing the goods are loaded onto a delivery vehicle 704. As an alternative step, a machine readable label 702 may be affixed to the container, identifying the goods and the quantity of goods in the container.

If it is advantageous to fist deliver the containers in the vehicle to a distribution center 706, the vehicle delivers the containers to the distribution center for eventual reloading onto delivery trucks for various intended destinations.

The contains are thereafter delivered to the storage facility, either directly from the point of origin, or via the distribution center. At the storage facility, the containers holding the goods are inserted into the storage and retrieval system. If a label identifying goods has been affixed to the container, the label is scanned, and the identity of the goods registered into a warehouse management system 708.

According to another aspect, the goods are restocked by virtue of the containers holding the goods by being automatically inserted by an automated container insertion device as illustrated in FIGS. 5-12, and as described in appendix A. According to this aspect, scanning device 605 may read label 702 and record the identity and quantity of the goods into the warehouse management system 708. Warehouse management system 708 registers and controls the inventory of the warehouse, and may be in electronic communication with control system 500 of the storage and retrieval system.

By utilizing the automated container insertion device, goods may be automatically restocked, and new containers automatically inserted into the storage system in a single operation.

If necessary, it is possible to remove an empty storage container from the system at essentially the time as a new container holding goods is inserted, in order to maintain the same total number of containers in the system. In such event, the empty container or containers can be returned to the point of origin for future use. This could for example include the use of collapsible containers for ease of transport.

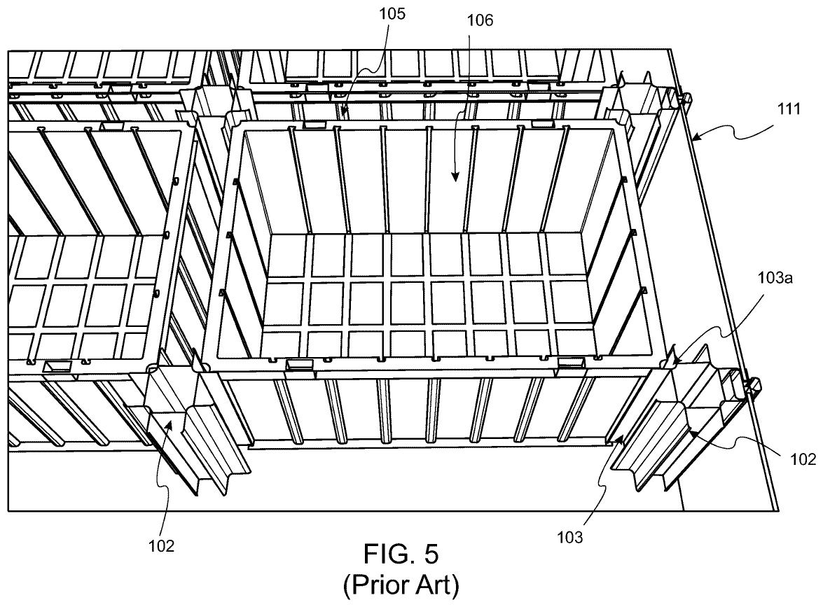

According to another aspect, an automated storage and retrieval system is provided, as illustrated in FIGS. 1-12 and described in Appendix A, and in which the system comprises a logistical routine as illustrated in FIG. 13 and described above.

### LIST OF REFERENCE NUMBERS

Prior art (FIGS. 1-4):
1 Prior art automated storage and retrieval system
100 Framework structure
102 Upright members of framework structure
104 Storage grid
103 Guide profile
103a Guide profile face
105 Storage column
106 Storage container
106′ Particular position of storage container
107 Stack
108 Rail system
110 Parallel rails in first direction (X)
111 Wall
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction
600 Bin/storage container insertion device
601 Compartment
602 Passage/storage container handling area
603 Conveyors
604 Labelling device
604a Label
605 ID Scanner
606 Dimension scanning deive
607 Platform
608 Entry
609 exit
610 ID tag
611 Wheels
613 Floor
614 Rear part
615 Forward part
617 Lateral opening in guide profile
619 Hinged segment
700 Point of origin
701 Goods
702 Goods label
704 Delivery vehicle
706 Distribution center
708 Warehouse management system

1. A method for stocking and/or restocking goods into an automated storage and retrieval system, the automated storage and retrieval system comprising a framework structure comprising a plurality of upright members defining a plurality of storage columns, said storage columns adapted to store stacks of storage containers, said storage containers comprising means to interface with a gripping device of an automated container handling vehicle operating on a rail system of the framework structure and thereby to be gripped by and lowered into or raised out of the storage columns by the vehicle, the method comprising the steps of:
a. packing the goods into one or more of said storage containers at a point of origin in order to form one or more stocked containers,
b. transporting the stocked container or containers from the point of origin to the automated storage and retrieval system location,
c. inserting the stocked container or containers into the automated storage and retrieval system, the step of inserting comprising;
i. affixing an identification label to a stocked container, the identification label comprising identifying information about the container,
ii. confirming that the physical dimensions of the container are within predefined tolerances,
iii. scanning the label or otherwise entering the identifying information into a control system of the automated storage and retrieval system,
iv. entering information about the goods within the stocked container into a warehouse management system,
v. retrieving the stocked containers by a container handling vehicle and transporting the stocked container to a storage column.

2. The method according to claim 1, wherein the point of origin is a manufacturer of the goods.

3. The method according to claim 1, wherein the point of origin is a distribution center.

4. The method according to claim 1, wherein a goods label is affixed to the container, the goods label comprising a machine readable code comprising information about the goods contained within the stocked container.

5. The method according to claim 1, wherein the stocked container is inserted into the automated storage and retrieval system by the use of a container insertion device arranged to insert containers into an automated storage and retrieval system laterally through a storage column of the system, the device comprising:
a conveyor arranged for transporting storage containers from a rear part of the insertion device to a forward part of the container insertion device,
an exit platform or support extending from the forward part of the container insertion device, the platform or support arranged to receive and support containers to be inserted into the storage and retrieval system, wherein the platform or support is dimensioned to be laterally inserted into the storage column and thereby support a storage container within the storage column for retrieval by a container-handling vehicle of the system, and
one or more of a label affixing device for affixing the identification label to a container, an ID scanning device for scanning the identification label, and/or a dimension scanning device arranged to measure the physical dimensions of the container, the one or more of said devices being in electronic communication with a control system of the storage and retrieval system.

6. The method according to claim 5, wherein the container insertion device further comprises a compartment that has a through-going passage for the storage containers with an entrance and an exit, wherein the compartment comprises at the least one of the said label affixing device, the ID scanner, and/or the dimension scanning device.

7. The method according to claim 5, wherein the exit platform of the container insertion device is arranged to be inserted through a lateral opening in the storage column, the lateral opening dimensioned to permit lateral insertion of a storage container.

8. The method according to claim 1, wherein the identification label and the goods label are at least one of: a barcode, a QR code, engraving on the storage container or any machine readable code that is read by the scanning device.

9. The method according to claim 1, wherein in connection with the insertion of a container into the system an empty container is removed from the system and returned to the point of origin for reuse.

10. An automated storage and retrieval system, comprising a framework structure forming a storage grid, the framework structure comprising:
a rail system arranged at an upper level of the framework structure, the rail system comprising a first set of parallel rails arranged in a horizontal plane and extending in a first direction, and a second set of parallel rails arranged in the horizontal plane and extending in a second direction which is orthogonal to the first direction, which first and second sets of rails form a grid pattern in the horizontal plane comprising a plurality of adjacent grid cells, and the storage grid defining a plurality of columns for use as storage columns, each storage column being arranged to store a respective stack of storage containers, wherein the storage columns are located beneath the rail system and wherein each storage column is located vertically below a respective grid cell,
a plurality of container handling vehicles that operate on the rail system for storing and retrieving storage containers to and from storage columns,
a control system configured for interacting with the system components and sending instructions to a plurality of container handling vehicles,
a warehouse management system for registering and monitoring the goods stored in the system,
wherein the automated storage and retrieval system comprises a logistics routine for the stocking or restocking of goods, the logistics routine comprising the method according to claim 1.
